(19) United States
(12) Patent Application Publication
(10) Pub. No.: US 2003/0014658 A1
(43) Pub. Date: Jan. 16, 2003

(54) System and method of verifying system attributes

(76) Inventors: Philip M. Walker, Fort Collins, CO (US); David J. Krenitsky, Fort Collins, CO (US)

Correspondence Address: HEWLETT-PACKARD COMPANY, Intellectual Property Administration, P. O. Box 272400, Fort Collins, CO, 80527-2400, US

(21) Appl. No.: 09/903,278

(22) Filed: Jul. 11, 2001

(51) Int. Cl. G06F 11/30

(52) U.S. Cl. 713/200

(57) ABSTRACT

A system includes a target, a probe operable to execute in the target and collect a predetermined set of data associated with the target, and a monitor operable to receive the collected predetermined set of data to compare with expected data values to determine whether the target has been altered. The collected data may include system attribute data and system usage data. The system usage data may be used to generate billing data if the system attribute data has been verified.

### TECHNICAL FIELD OF THE INVENTION

This invention relates to computer systems, and more particularly, to a system and method of verifying system attributes.

### BACKGROUND OF THE INVENTION

Computer systems, servers, data storage devices and other equipment are increasingly leased to customers following a usage-based billing model rather than a time-based billing model. The usage-based lease charge is based on, for example, the amount of CPU time, disk storage, and network usage a customer consumes. In order to prepare accurate billing statements, equipment usage data must be accurately measured and collected. Leased computers are equipped with hardware and/or software to record and report accurate accounting data on usage. However, because leased systems are no longer operating in secured environment and under the control of the lessor, unscrupulous lessees may tamper with the system to alter the recorded usage data in an attempt to reduce the rental charges.

### SUMMARY OF THE INVENTION

Therefore, there is a desire to be able to verify system attributes in order to detect attacks on the system by subversive tactics so that alteration of system data, including usage data, can be detected.

In accordance with an embodiment of the present invention, a system includes a target, a probe operable to execute in the target and collect a predetermined set of data associated with the target, and a monitor operable to receive the collected predetermined set of data to compare with expected data values to determine whether the target has been altered.

In accordance with another embodiment of the present invention, a method includes the steps of executing a probe in a target, and collecting a predetermined set of data associated with the target for comparison with expected data values for the predetermined set of data to determine whether the target has been altered.

In accordance with yet another embodiment of the present invention, a method includes the steps of initiating the execution of a probe in a target, receiving from the probe a predetermined set of data associated with the target, and comparing the received predetermined set of data with expected data values thereof to determine whether the target has been altered.

### BRIEF DESCRIPTION OF THE DRAWINGS

For a more complete understanding of the present invention, the objects and advantages thereof, reference is now made to the following descriptions taken in connection with the accompanying drawings in which:

FIG. 1 is a simplified block diagram of an embodiment of a system attribute verification process according to the teachings of the present invention;

FIG. 2 is a simplified block diagram of another embodiment of a system attribute verification process according to the teachings of the present invention;

FIG. 3 is a simplified flowchart of an embodiment of a portion of the system attribute verification process according to the teachings of the present invention; and

FIG. 4 is simplified flowchart of another embodiment of a portion of the system attribute verification process according to the teachings of the present invention.

### DETAILED DESCRIPTION OF THE DRAWINGS

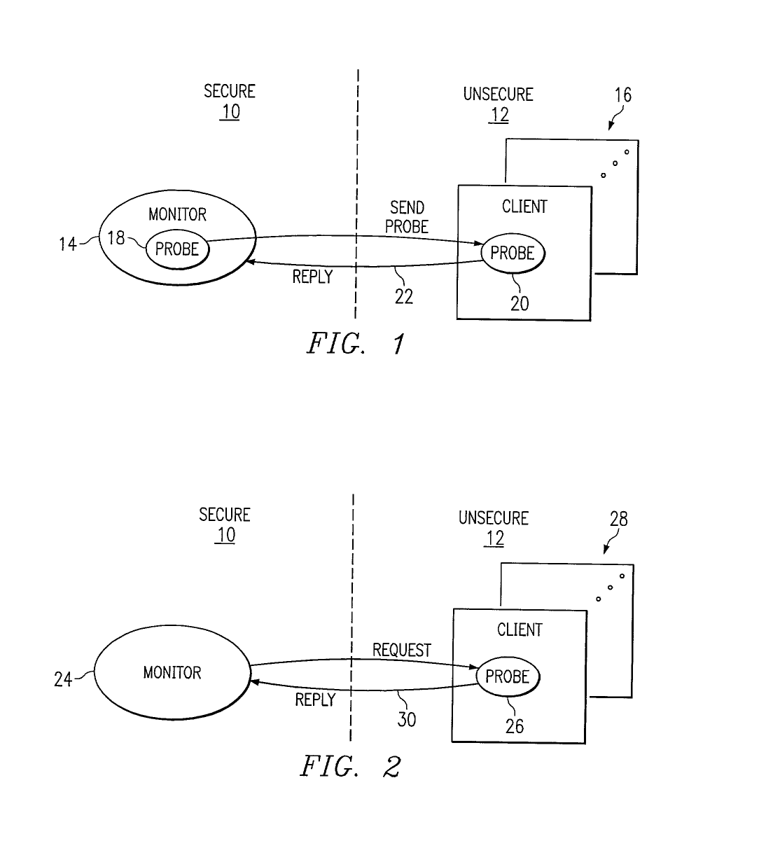

The preferred embodiment of the present invention and its advantages are best understood by referring to FIGS. 1 through 4 of the drawings, like numerals being used for like and corresponding parts of the various drawings.

It is desirable to provide a way to verify the computer system attributes to ensure that the usage accounting and reporting of the system have not been altered in an unauthorized manner. The present invention either sends a probe program to the target computer system or remotely invokes a probe program resident at the target computer to check on a number of system attributes and generate status data. In order to verify that the resident probe program itself has not been tampered with, a hash or digital signature of the probe program is generated to ensure it is the original program.

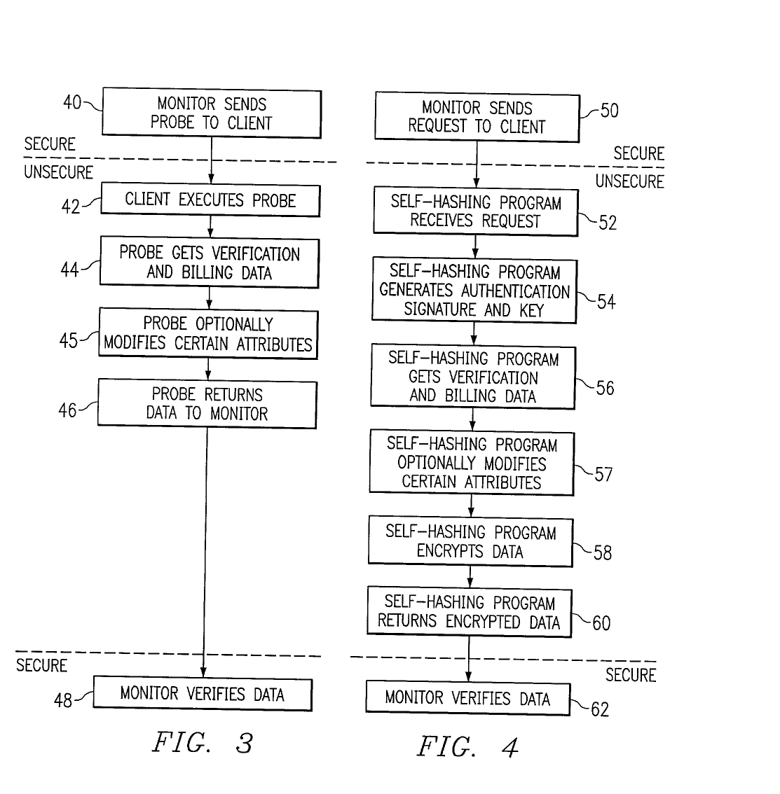

FIG. 1 is a simplified block diagram of an embodiment of a system attribute verification process according to the teachings of the present invention. Referring also to FIG. 3, a flowchart provides additional details of the process. When computers or other equipment are leased to customers, they are no longer operating in a secured environment 10, but are operating in an unsecured environment 12 in which they are subject to tampering and other unauthorized alterations. According to the present invention, a monitor 14 which resides in secured environment 10 is operable to verify the system attributes of at least one client system 16 operating in unsecured environment 12. Client systems 16 serve as the target of the inquiry and may be computers, servers and other equipment leased to customers on a usage-based billing model. On a periodic schedule, an as-need basis, or in a random manner, monitor 14 dispatches a probe 18 or invokes a copy 20 of the probe to client system 16, as shown in step 40 in FIG. 3. Probe 18 may be a software application written in any suitable computer language that is ready for execution. Probe 20, now in client system 16, is then launched by client system 16 in step 42. Alternatively, probe 20 may be a self-executing (for example, as a cron job which automates repetitive executions) program that does not rely on client system 16 to initiate its execution.

In step 44, probe 20 gets attribute data associated with the client systems such as verification data and billing data. Verification data comprises any information acquired or inferred by the process of sampling and/or modifying various aspects of the target system, involving physical hardware state and/or system files. Probe 20 has instructions to gather data on a list of system attributes and parameters from client system 16. System attributes and parameters may include a serial number of the CPU (central processing unit) or another system component, the current disk type, the dates, size, or other parameters of a specific set of system files, the physical position on a disk drive of certain system files, the network MAC (media access control) address, etc. Furthermore, probe 20 is optionally instructed to obtain information on usage, such as memory usage, disk storage usage, CPU usage, etc. for billing purposes. Probe 20 may have instructions to change the value of certain system attributes, as shown in step 45. Probe 20 then constructs a reply 22 to include the verification data and usage data and returns the reply to monitor 14 in step 46. Monitor 14 then uses the verification data to determine whether the billing data returned by probe 20 is reliable.

Monitor 14 checks the verification data returned by probe 20 to determine whether they matched the expected values. If there is a mismatch, there is a possibility that client system 16 has been altered in an unauthorized manner and that the returned usage data may not be trustworthy.

As a further preventive measure, the set of system attribute and parameter data obtained by probe 20 may change each time probe executes. This may be accomplished by sending a different probe each time or by varying the list of data that probe is instructed to collect. Therefore, it is difficult to anticipate which system attributes will be the requested verification data. The probe may optionally change the value of certain system attributes so that the next probe execution may fetch a different set of verification data, including data that may have been set or changed by the previous probe program. Because a new probe program may be sent each time, attempts to de-compile the probe program in order to gain insight into its operations and the verification data it collects are made much more difficult and expensive. The transmitted probe embodiment of the present invention takes advantage of the opportunity to establish communication between the monitor and the probe without dependency on any particular communication protocol. For example, the protocol may be a published standard such as telnet, ftp, snmp, https, and others. The protocol may also be other published or private protocols or variations thereof. For example, the telnet protocol is normally initiated using a well-known port number (23). This may be modified. Normally, responses are expected to be sent to the return port specified in an incoming packet. This port number could instead be used to seed a pseudo-random number generator, or otherwise manipulated to generate the actual expected return port. The primary goal is to make the task of reverse engineering the protocol difficult and expensive.

FIG. 2 is a simplified block diagram of another embodiment of a system attribute verification process, and FIG. 4 is simplified flowchart of the system attribute verification process according to the teachings of the present invention. Unlike the first embodiment where the monitor sends a probe program to the client system, a monitor 24 sends a request to execute a probe 26 already resident in client system 28 as shown in step 50. Because probe 26 resides in unsecured environment 12, additional measures are preferably taken to ensure that it has not been altered in an unauthorized manner.

Probe 26 is preferably a self-hashing program that executes upon receiving the request from monitor 24, as shown in step 52. Probe 26 generates an authentication signature of the executing image of itself in step 54. Algorithms such as a one-way hash function (also known as compression function, contraction function, fingerprint, cryptographic checksum, etc.) can be used to generate an output string or hash value from a given input string or pre-image. One can generate the hash value from the pre-image by using the hash function, but cannot reverse the process and generate the pre-image from the hash value. One-way hash functions are described in the second edition of “Applied Cryptography, Protocols, Algorithms, and Source Code in C” by Bruce Schneier, published by John Wiley & Sons, Inc. To prevent the anticipation of a hash value since the probe program is not changed each time for each execution, a random and varying subset of the probe program may be used to generate the hash value. For example, the probe may search for the first occurrence of a predetermined bit pattern and then hash the next N number of bytes in a specific portion of the program. The probe may further modify itself according to some algorithm before generating the hash value or modify the resultant hash value according to some other suitable algorithm.

Probe 26 may use the resultant hash value or signature as a key to encrypt the reply containing the verification data and usage data. The key may also be calculated or determined using an algorithm to further manipulate the resultant hash value. The probe program may further hash only predetermined number of bytes of code of the program and use it as the basis for determining the encryption key. Probe 26 then collects the verification data and usage data of client system 28 in step 56 and encrypts the data in step 58 using the generated key. In addition, probe 26 may have instructions to change the value of certain system attributes in step 57. Therefore, the next probe execution not only may fetch a different set of verification data, some data may have been set or changed by the previous probe program. A reply 30 is constructed from the encrypted verification and usage data and returned to monitor 24 in step 60. Monitor 24 then verifies the received reply and checks for its authenticity in step 62. Monitor 24 decrypts the reply using the key it expects to have been used during encryption by the probe program to decrypt the reply. Monitor 24 then matches the hash value from the decrypted reply to what it expects the probe program hash value to be. If they match, then the probe program has not been tampered with. Monitor 24 then may verify the system verification data contained in the decrypted reply. Monitor 24 checks the verification data returned by the probe to determine if they matched the expected values. If there is a mismatch, there is a possibility that the client system has been altered in an unauthorized manner and that the returned usage data may not be trustworthy.

The second embodiment of the present invention reduces the bandwidth requirement since it is not required to send the entire probe executable image to the client system, and may only send a limited set of invocation parameters. However, the probe program has more exposure to attacks since it is resident in the unsecured client systems. A software patch may be transmitted as part of the invocation message to modify the probe executable image to make reverse engineering more difficult.

In general, attacks to computer systems can be categorized into three types. The embodiments of the present invention are applicable to all three types of attacks. In a type 1 attack, the probe program is overcome or disabled and a false reply is generated and sent back to the monitor. In some instances, unsophisticated attempts at type 1 attacks result in no replies being generated and sent back. Type 1 attacks are generally easy to detect by verifying the values of a simple set of verification data. In a type 2 attack, the request for verification and usage data is diverted to a different computer or a virtual system. The present invention detects such attacks by checking a random subset of all possible system attributes, and further randomly modifying the values of these system attributes in a unique and unpredictable manner. If the physical security of the target system is controlled and therefore known, then only the system configuration may need to be verified, thus simplifying the verification problem. For example, if all external network communications to the target system can be controlled, and can therefore be temporarily blocked or delayed during a probe invocation period, then the only way for a system client to use attack type 2 would be to divert probe invocations to a virtual OS on the client system itself. This would be detectable by sampling various system attributes that would be expected to be different between the original system and a virtual clone running on the original system. For example, the sample may include current system mounts and their usage statistics and the number of the highest INODE (for example) in the system. An INODE is a data structure that holds information about a file in a UNIX system. Each file in the UNIX system has a corresponding INODE. Furthermore, a comparison of benchmarks affected differently by a virtual OS environment may be used to detect a type 2 attack. In a type 3 attack also commonly known as the man-in-the-middle attack, an intermediate system intercepts the probe or the request, executes the probe on the target client system, intercepts the returned reply and modifies the usage data. Type 3 attacks are the most sophisticated and the most difficult to detect. Known tactics to foil such attacks includes the interlock protocol as described in Schneier's “Applied Cryptography” set forth above, which involves encrypting the reply and sending only half of the encrypted reply, which cannot be decrypted without the other half. The present invention may incorporate these other techniques in order to overcome these attacks. Other anti-type 3 attack methods includes timing the requests and corresponding replies to ensure that the time lapse between the request and reply doesn't allow for an intermediate system to intercept and alter the reply.

The present invention may further be used to periodically verify the target system state when it is in a secure environment. The target system may be periodically disconnected from client control for the purpose of reverifying its state under secure conditions. The advantage of doing so is to simplify the number of critical system parameters that must be dynamically monitored while the target system is unsecured.

What is claimed is:

1. A system comprising:
a target;
a probe operable to execute in the target and collect a predetermined set of data associated with the target; and
a monitor operable to receive the collected predetermined set of data to compare with expected data values to determine whether the target has been altered.

2. The system, as set forth in claim 1, wherein the probe is resident in the target.

3. The system, as set forth in claim 1, wherein the monitor is operable to send the probe to the target for execution.

4. The system, as set forth in claim 1, wherein the probe repeatedly executes and the predetermined set of data varies for each execution of the probe.

5. The system, as set forth in claim 1, wherein the predetermined set of data includes system attributes and system usage data.

6. The system, as set forth in claim 1, wherein the probe is operable to calculate a signature value of at least a portion of an execution image of the probe.

7. The system, as set forth in claim 1, wherein the monitor is operable to compare the calculated signature value to an expected signature value.

8. The system, as set forth in claim 1, wherein the probe is operable to determine a signature value of a random subset of an execution image of the probe.

9. The system, as set forth in claim 1, wherein the probe is operable to generate an encryption key from the signature value for encrypting the collected predetermined set of data.

10. A method comprising:
executing a probe in a target;
collecting a predetermined set of data associated with the target for comparison with expected data values for the predetermined set of data to determine whether the target has been altered.

11. The method, as set forth in claim 10, further comprising receiving a request to execute the probe resident in the target.

12. The method, as set forth in claim 10, further comprising receiving the probe and executing the received probe in the target.

13. The method, as set forth in claim 10, wherein the step of executing a probe is repeated.

14. The method, as set forth in claim 10, wherein the step of executing a probe comprises collecting a different predetermined set of data for each execution of the probe.

15. The method, as set forth in claim 10, further comprising calculating a signature value of at least a portion of the probe for comparison to an expected signature value.

16. The method, as set forth in claim 10, further comprising calculating a signature value of the probe for comparison to an expected signature value.

17. The method, as set forth in claim 16, further comprising:
generating an encryption key from the signature value; and
encrypting the collected predetermined set of data with the encryption key.

18. The method, as set forth in claim 17, further comprising:
sending the encrypted data to a monitor, the data including system attribute data and system usage data;
decrypting the encrypted data using a decryption key;
verifying the system attribute data; and
generating billing data based on the system usage data in response to the system attribute data being verified.

19. A method comprising:
initiating the execution of a probe in a target;
receiving from the probe a predetermined set of data associated with the target; and
comparing the received predetermined set of data with expected data values thereof to determine whether the target has been altered.

20. The method, as set forth in claim 19, further comprising sending a request to the probe resident in the target to initiate the execution.

21. The method, as set forth in claim 19, further comprising sending the probe and executing the probe in the target.

22. The method, as set forth in claim 19, wherein initiating the execution of a probe comprises repeating execution of the probe.

23. The method, as set forth in claim 19, wherein initiating the execution of a probe comprises collecting a different predetermined set of data for each execution of the probe.

24. The method, as set forth in claim 19, further comprising:
receiving collected data encrypted by the probe using an encryption key derived from a self-hash value, the data including system attribute data and system usage data;
decrypting the encrypted data; and
verifying the system attribute data.

25. The method, as set forth in claim 23, further comprising generating billing data based on the system usage data in response to the system attribute data being verified.

26. The method, as set forth in claim 19, further comprising:
receiving a reply containing at least the collected predetermined set of data, the data including system attribute data and system usage data; and
verifying the system attribute data.
